(19) United States
(12) Patent Application Publication
(10) Pub. No.: US 2026/0047668 A1
(43) Pub. Date: Feb. 19, 2026

(54) Toothbrush With Suction Tube

(71) Applicant: Michael Murano, Buena Park, CA (US)

(72) Inventor: Michael Murano, Buena Park, CA (US)

(21) Appl. No.: 18/805,189

(22) Filed: Aug. 14, 2024

(51) Int. Cl. A46B 5/00; A46B 9/04; A46B 15/00; A61C 17/02

(52) U.S. Cl. CPC A46B 5/00; A46B 9/04; A46B 15/0055; A61C 17/02; A46B 2200/1066

(57) ABSTRACT

A toothbrush includes a handle, a brush head, a port, and a tube. The handle has a first end and a second end. The brush head is attached to the first end of the handle. The port is positioned in the handle at the first end. The tube extends from the port, through the handle, and to an opening in the second end of the handle to permit suction of water through the handle to a mouth of a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to toothbrushes and more particularly pertains to a new toothbrush that has a tube inside the handle to allow users to suck water through a port at the brush head, then through the handle, and then out into the mouth of the user. In this manner, the user can obtain water for rinsing out his or her mouth without the need for a cup. In addition, the user can avoid cupping up the water with his or her hands or placing his or her mouth at a faucet to maintain hygiene and avoid contact with contaminants or microorganisms. The toothbrush would be useful for persons who may have difficulty handling a cup, such as children, the elderly, or some disabled. The toothbrush would also be useful for persons in public bathrooms where cups may not be available and the conditions may not be very hygienic.

### (2) Description of Related Art Including Information Disclosed Under 37 CFR 1.97 and 1.98

The prior art relates to toothbrushes. The prior art, as best understood, does not disclose a toothbrush that as a port positioned in the handle at the first end and a tube that extends from the port, through the handle, and to an opening in the second end of the handle to permit suction of water through the handle to a mouth of a user.

### BRIEF SUMMARY OF THE INVENTION

An embodiment of the disclosure meets the needs presented above in a toothbrush generally comprising a handle, a brush head, a port, and a tube. The handle has a first end and a second end. The brush head is attached to the first end of the handle. The port is positioned in the handle at the first end. The tube extends from the port, through the handle, and to an opening in the second end of the handle to permit suction of water through the handle to a mouth of a user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of a toothbrush according to an embodiment of the disclosure.

FIG. 2 is a front perspective view of an embodiment of the disclosure.

FIG. 3 is a rear view of an embodiment of the disclosure in use.

FIG. 4 is a side view of an embodiment of the disclosure in use.

### DETAILED DESCRIPTION OF THE INVENTION

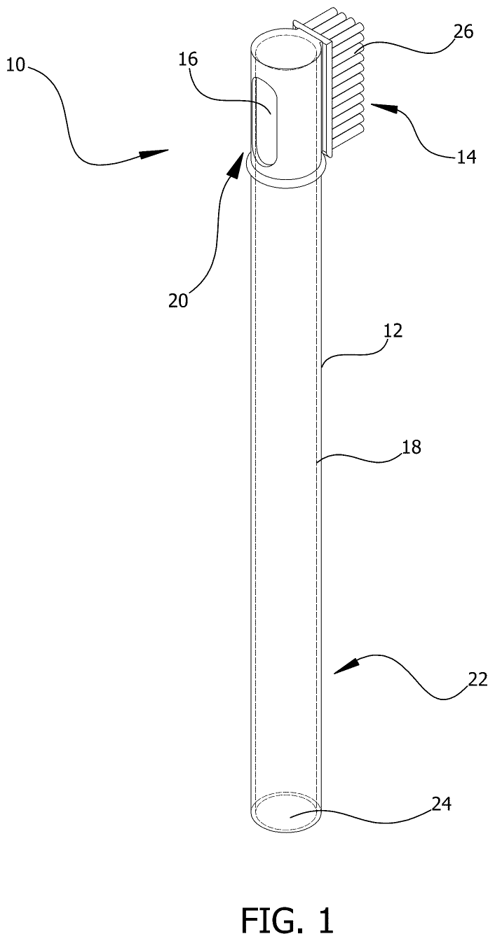

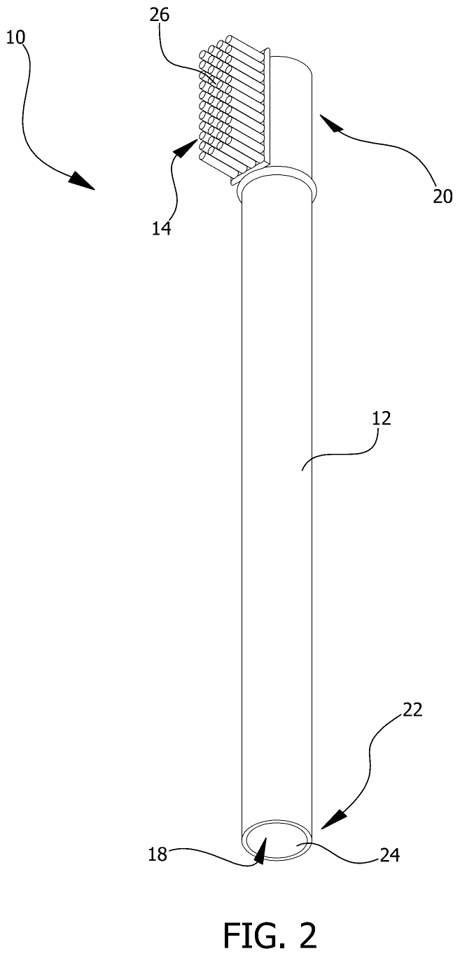

With reference now to the drawings, and in particular to FIGS. 1 through 4 thereof, a new toothbrush embodying the principles and concepts of an embodiment of the disclosure and generally designated by the reference numeral 10 will be described.

As best illustrated in FIGS. 1 through 4, the toothbrush 10 generally comprises a handle 12, a brush head 14, a port 16, and a tube 18. The handle 12 has a first end 20 and a second end 22. The brush head 14 is attached to the first end 20 of the handle 12. The port 16 is positioned in the handle 12 at the first end 20. The tube 18 extends from the port 16, through the handle 12, and to an opening 24 in the second end 22 of the handle 12 to permit suction of water 60 through the handle 12 to a mouth 62 of a user.

In the exemplary embodiment shown in FIG. 1, the tube 18 is integrally formed in the handle 12 such that the handle 12 is essentially hollow. In another possible embodiment, the tube 18 could be a separate component mounted or otherwise attached inside the handle 12. For example, the tube 18 could be made of medical-grade material that is resistant to build up of microorganisms or other biological contaminants, whereas the handle 12 could be made of durable plastic. In the integral design, the handle 12 is made of BPA-free food-grade plastic.

In the exemplary embodiment in FIG. 1, the brush head 14 includes a plurality of bristles 26. The port 16 is positioned opposite and facing away from the brush head 14.

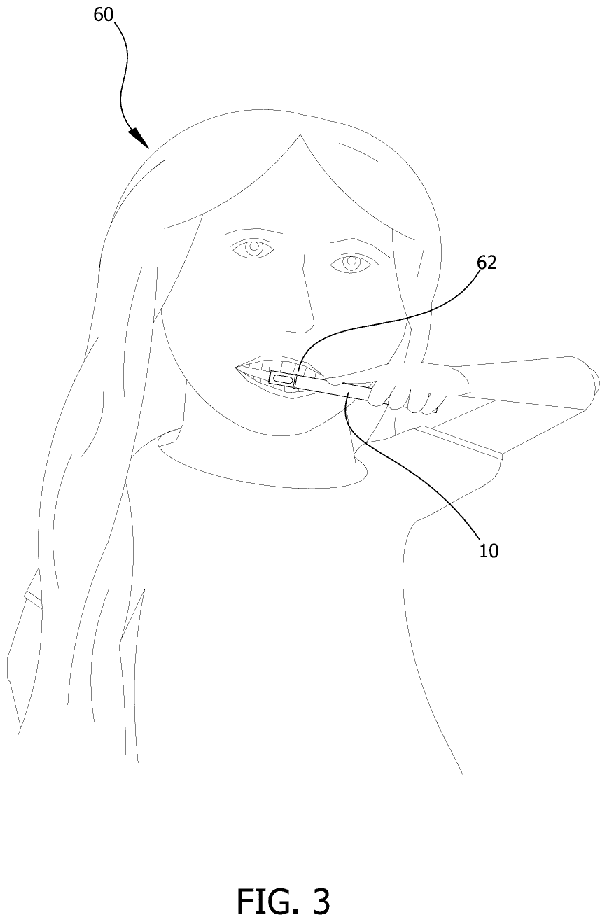

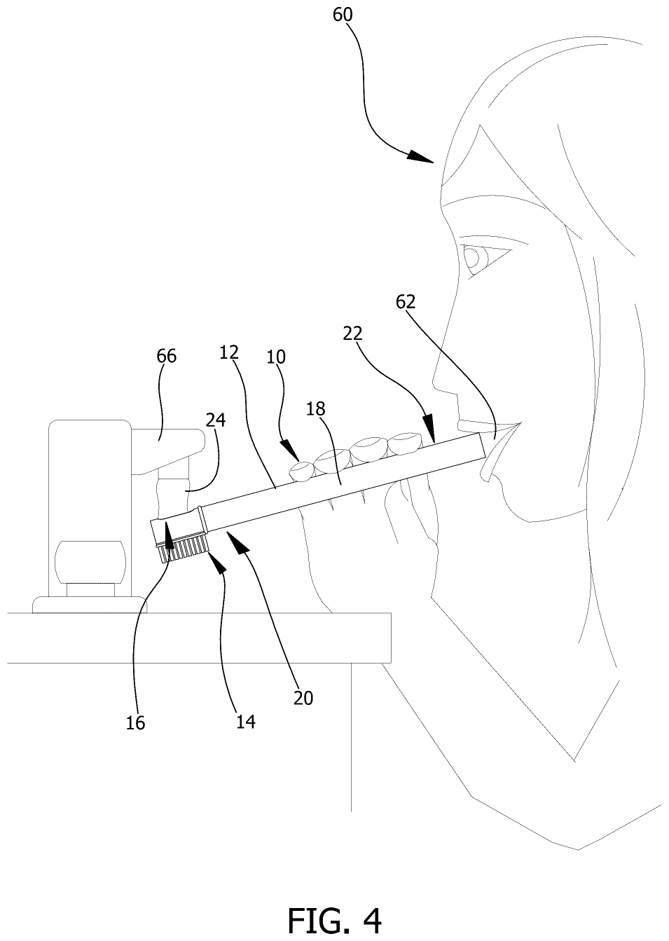

FIGS. 3 and 4 show how to use the toothbrush 10. The user 60 first cleans his or her teeth with the brush head 14 as is normally done. However, when it is time to rinse out the mouth 62 of the user 60 with water 64, the user 60 places the port 16 under a water dispenser, in this case a faucet 66, and then dispenses water 64 into the port 16. The user 60 places the second end 22 of the handle 12 in his or her mouth 62. The user 60 then sucks the water 64 through the port 16 and into the tube 18, then through the handle 12, and through the opening 24 in the second end 22 of the handle 12 and into the mouth 62 of the user 60. The user 60 can now use the water 64 to rinse out his or her mouth 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A toothbrush comprising:
a handle having a first end and a second end;
a brush head attached to said first end of said handle;
a port disposed in said handle at said first end; and
a tube extending from said port, through said handle, and to an opening in said second end of said handle to permit suction of water through said handle to a mouth of a user.

2. The toothbrush of claim 1, wherein said handle comprises BPA-free food-grade plastic.

3. The toothbrush of claim 1, wherein said brush head comprises a plurality of bristles.

4. The toothbrush of claim 1, wherein said port is disposed opposite and facing away from said brush head.

5. The toothbrush of claim 1, wherein said tube is integrally formed in said handle such that said handle is essentially hollow.

6. The toothbrush of claim 5, wherein said handle comprises BPA-free food-grade plastic.

7. The toothbrush of claim 6, wherein said brush head comprises a plurality of bristles.

8. The toothbrush of claim 7, wherein said port is disposed opposite and facing away from said brush head.

9. A method of using a toothbrush comprising a handle having a first end and a second end; a brush head attached to said first end of said handle; a port disposed in said handle at said first end; and a tube extending from said port, through said handle, and to an opening in said second end of said handle to permit suction of water through said handle to a mouth of a user, wherein said method comprises the steps of:
cleaning teeth of a user with said brush head;
placing said port under a water dispenser and dispensing water into said port;
placing said second end of said handle in a mouth of the user and sucking the water through said port and into said tube, then through said handle, and through said opening in said second end of said handle and into the mouth of the user; and
rinsing out the mouth with the water.
